(19) United States
(12) Patent Application Publication
(10) Pub. No.: US 2020/0311162 A1
(43) Pub. Date: Oct. 1, 2020

(54) SELECTING RECOMMENDATIONS BASED ON TITLE TRANSITION EMBEDDINGS

(71) Applicant: Microsoft Technology Licensing, LLC, Redmond, WA (US)

(72) Inventors: Junrui Xu, Fremont, CA (US); Meng Meng, San Jose, CA (US); Girish Kathalagiri Somashekariah, Santa Clara, CA (US); Huichao Xue, Santa Clara, CA (US); Varun Mithal, Sunnyvale, CA (US); Ada Cheuk Ying Yu, Santa Clara, CA (US)

(73) Assignee: Microsoft Technology Licensing, LLC, Redmond, WA (US)

(21) Appl. No.: 16/367,716

(22) Filed: Mar. 28, 2019

(51) Int. Cl. G06F 16/9536; G06F 16/903; G06N 20/00

(52) U.S. Cl. CPC G06F 16/9536; G06N 20/00; G06F 16/90335

(57) ABSTRACT

The disclosed embodiments provide a system for selecting recommendations based on title transition embeddings. During operation, the system obtains a word embedding model of a set of job histories. Next, the system calculates similarities between pairs of the embeddings produced by the word embedding model from attributes associated with titles in the set of job histories. The system then identifies, based on the similarities, job titles with high similarity to a current title of the candidate. Finally, the system outputs the job titles for use in selecting job recommendations for the candidate.

### BACKGROUND

### Field

The disclosed embodiments relate to user recommendations. More specifically, the disclosed embodiments relate to techniques for selecting recommendations based on title transition embeddings.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of selecting recommendations based on title transition embeddings in accordance with the disclosed embodiments.

FIG. 4 shows a flowchart illustrating a process of producing a word embedding model of job histories in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for selecting job recommendations. The job recommendations may be customized to users that browse and/or search for job postings, users that are identified as job seekers, and/or other types of candidates and potential candidates for jobs. For example, the job recommendations may include jobs that are matched to the candidates' education, work experience, skills, level of seniority, location, current titles, and/or past titles.

More specifically, the disclosed embodiments provide a method, apparatus, and system for selecting potential job recommendations based on title transition embeddings. The title transition embeddings include word embeddings for past and current titles of a set of users, such as job candidates and/or members of an online network. For example, a word embedding model may be trained using a collection and/or series of standardized job titles, industries, company names, schools, and/or fields of study in each user's education and/or job history. The word embedding model may then be used to convert titles and/or other attributes in the job histories into embeddings that are vector representations of the attributes.

As a result, the word embedding model captures patterns and/or semantic relationships among titles in the users' job histories, so that similarities and/or trends in titles within the job histories are reflected in calculations of similarity between the corresponding embeddings. For example, a cosine similarity that is calculated between two titles that are frequently found together in the users' job histories may be higher than a cosine similarity that is calculated between two titles that are not typically found together in the job histories.

In one embodiment, similarities between embeddings of titles are used to select and/or filter jobs to recommend to a set of candidates. For example, cosine similarities may be calculated between embeddings of a candidate's current title, past titles, and/or preferred title (e.g., the candidate's preferred “next step” in his/her career path) and job titles of posted jobs. The cosine similarities are used to identify posted jobs with titles that are highly similar to the candidate's current title, past titles, and/or preferred title. Features for the identified job postings are then inputted into a machine learning model that predicts the candidate's likelihood of applying to each posted job. Scores from the machine learning model are then used to rank the posted jobs and select a highest-ranked subset of posted jobs as recommendations for the candidate.

By using embeddings that capture title transition relationships and/or trends to identify jobs with high similarity to titles held and/or preferred by candidates, the disclosed embodiments allow job recommendations for the candidates to be selected and/or generated from the highly similar jobs. The disclosed embodiments may thus prevent jobs that lack similarity to the candidates' titles and/or title preferences from appearing in the job recommendations, thereby increasing the relevance and/or quality of the job recommendations for the candidates. In contrast, conventional techniques may generate recommendations based on exact matches with the candidates' job search queries and/or title preferences, which may limit the recommendations to a small and/or narrow set of jobs. The conventional techniques may also, or instead, score and/or rank lists of jobs that have not been filtered to reflect the candidates' explicit or inferred job or title preferences, resulting in recommendations of jobs that lack relevance to the candidates' career or job search preferences. Consequently, the disclosed embodiments may improve computer systems, applications, user experiences, tools, and/or technologies related to user recommendations, employment, recruiting, and/or hiring.

### Selecting Job Recommendations Based on Title Transition Embeddings

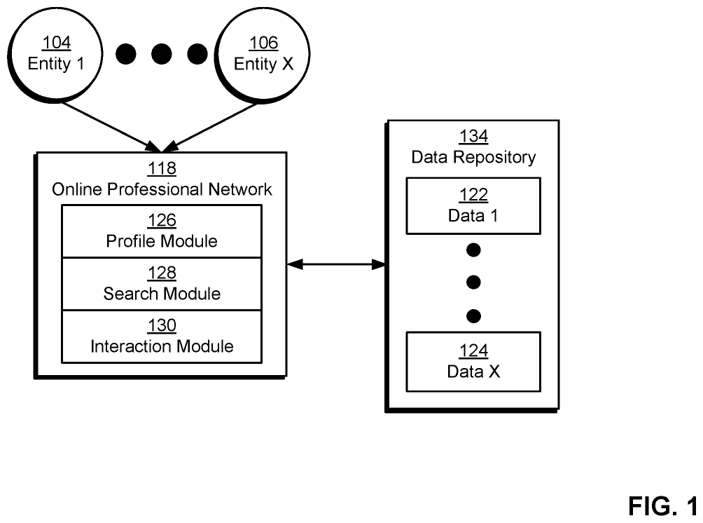

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

More specifically, data in data repository 134 and one or more machine learning models are used to produce rankings related to matching candidates with jobs or opportunities listed within or outside online network 118. The candidates may include users who have viewed, searched for, or applied to jobs, positions, roles, and/or opportunities, within or outside online network 118. The candidates may also, or instead, include users and/or members of online network 118 with skills, work experience, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). The machine learning model(s) may output scores representing the strength of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights may improve the quality of the candidates and/or recommendations of opportunities to the candidates, increase user activity with online network 118, and/or guide the decisions of the candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may recommend highly ranked candidates for a position to recruiters and/or other moderators as potential applicants and/or interview candidates for the position. In a fourth example, the component(s) may recommend jobs to a candidate based on the predicted relevance or attractiveness of the jobs to the candidate and/or the candidate's likelihood of applying to the jobs.

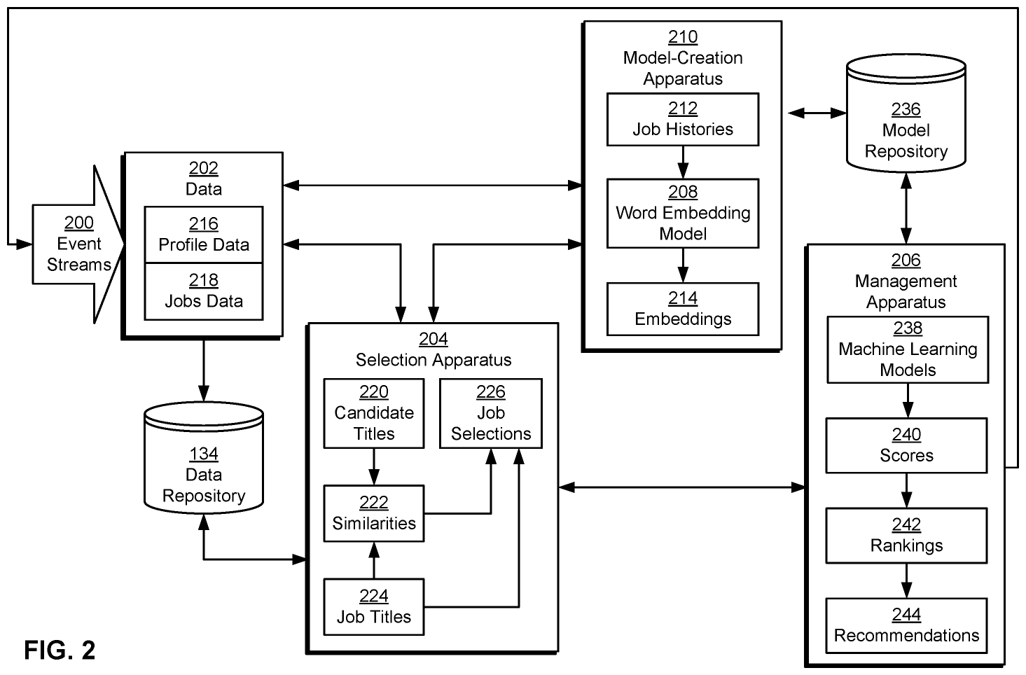

In one or more embodiments, online network 118 includes functionality to improve the timeliness, relevance, and/or accuracy of recommendations related to candidates and/or opportunities. As shown in FIG. 2, data repository 134 and/or another primary data store may be queried for data 202 that includes profile data 216 for members of an online network (e.g., online network 118 of FIG. 1), as well as jobs data 218 for jobs that are listed or described within or outside the online network.

Profile data 216 includes data associated with member profiles in the online network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online network.

Attributes of the members from profile data 216 may be matched to a number of member segments, with each member segment containing a group of members that share one or more common attributes. For example, member segments in the online network may be defined to include members with the same industry, title, location, and/or language.

Connection information in profile data 216 may additionally be combined into a graph, with nodes in the graph representing entities (e.g., users, schools, companies, locations, etc.) in the online network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online network. For example, jobs data 218 for a given job or job listing may include a declared or inferred title, company, required or desired skills, responsibilities, qualifications, role, location, industry, seniority, salary range, benefits, and/or member segment.

Profile data 216 and/or jobs data 218 may further include job histories 212 of members of the online network. Each job history may include a chronological sequence of jobs for a given member that terminates in the member's current job and/or the member's most recently listed job. As a result, the job history may be assembled from current and/or previous jobs listed in the member's current profile data 216. For example, the job history may include titles, functions, companies, locations, industries, seniorities, locations, and/or other attributes of the member's current and/or previous jobs. The job history may optionally include schools, fields of study, and/or degrees from the member's educational background.

Job histories 212 may be supplemented with job listings, job descriptions, and/or other information in jobs data 218. For example, a job that is posted in the online network may be matched to a member that applies for and subsequently accepts an offer for the job. In turn, the job in the member's job history may be populated and/or associated with skills, benefits, qualifications, requirements, salary information, and/or other information from the job listing.

In one or more embodiments, data repository 134 stores data that represents standardized, organized, and/or classified attributes in profile data 216 and/or jobs data 218. For example, skills in profile data 216 and/or jobs data 218 may be organized into a hierarchical taxonomy that is stored in data repository 134. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

Data 202 in data repository 134 may further be updated using records of recent activity received over one or more event streams 200. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the community may be generated in response to the activity. The record may then be propagated to components subscribing to event streams 200 on a nearline basis.

A model-creation apparatus 210 creates a word embedding model 208 from attributes in job histories 212. After word embedding model 208 is created, word embedding model 208 generates embeddings 214 based on attributes in profile data 216 and/or jobs data 218. For example, word embedding model 208 may be a word2vec model that outputs embeddings 214 in a vector space based on groupings of standardized attributes in job histories 212 from data repository 134.

More specifically, model-creation apparatus 210 generates a collection of standardized job titles, company names, industries, school names, fields of study, and/or other attributes from each member's job history and inputs the collection as a “document” into word embedding model 208. The document includes a “sentence” containing a series of educational attributes (e.g., one or more schools and the corresponding fields of study) followed by a series of job-related attributes (e.g., company, function, title, and/or industry for each job) from the member's job history. As a result, model-creation apparatus 210 may train word embedding model 208 so that standardized attributes that are shared by a relatively large proportion of job histories 212 are closer to one another in the vector space than standardized attributes that are shared by a smaller proportion of job histories 212. In other words, word embedding model 208 may capture patterns and/or semantic relationships among titles and/or other attributes in job histories 212, so that similarities and/or trends in the attributes within job histories 212 are reflected in distances among embeddings 214 outputted by word embedding model 208.

After word embedding model 208 is created and/or updated, model-creation apparatus 210 stores parameters of word embedding model 208 in a model repository 236. For example, model-creation apparatus 210 may replace old values of the parameters in model repository 236 with the updated parameters, or model-creation apparatus 208 may store the updated parameters separately from the old values (e.g., by storing each set of parameters with a different version number of the corresponding machine learning model).

A selection apparatus 204 uses word embedding model 208 and/or embeddings 214 to calculate similarities 222 between candidate titles 220 related to candidates for jobs and job titles 224 of jobs listed within or outside the online network. For example, selection apparatus 204 may use word embedding model 208 from model-creation apparatus 210 and/or model repository 236 to generate an embedding of each standardized title found in profile data 216, jobs data 218, and/or other data 202 in data repository 134. Selection apparatus 204 may optionally include, with each title inputted into word embedding model 208, additional attributes associated with the title (e.g., industry, company, location, seniority, etc.). Selection apparatus 204 may then calculate a cosine similarity, cross product, Euclidean distance, and/or other measure of vector similarity between pairs of embeddings 214 outputted by word embedding model 208.

Selection apparatus 204 uses similarities 222 between candidate titles 220 related to a candidate and job titles 224 of jobs to generate job selections 226 for the candidate. Candidate titles 220 include one or more standardized titles that indicate and/or represent the candidate's job-seeking and/or career path preferences. For example, candidate titles 220 may include the candidate's current title, past titles, and/or declared or inferred title preference in candidate titles 220. Candidate titles 220 may also, or instead, include the titles of one or more jobs to which the candidate has recently applied.

Job titles 224 include standardized titles that are found in jobs posted within or outside the online network. Job titles 224 may also, or instead, include standardized titles for some or all jobs in data repository 134, including jobs listed in member profiles and/or other types of data 202 in data repository 134.

In one or more embodiments, job selections 226 include jobs with job titles 224 that have high similarity to candidate titles 220 that reflect the candidate's job-seeking and/or career path preferences. As a result, selection apparatus 204 may identify job selections 226 based on rankings and/or thresholds associated with similarities 222 between embeddings 214 of candidate titles 220 and embeddings 214 of job titles 224. For example, selection apparatus 204 may order job titles 224 by descending similarity to one or more candidate titles 220 for the candidate. Selection apparatus 204 may then identify a pre-specified number of highest-ranked job titles 224 in the ranking (i.e., job titles 224 with the highest similarities 222 to candidate titles 220) and generate job selections 226 as jobs that include the highest-ranked job titles 224.

In another example, selection apparatus 204 may apply a numeric and/or percentile threshold to similarities 222 calculated between embeddings 214 of candidate titles 220 and embeddings 214 of job titles 224. Selection apparatus 204 may then produce job selections 226 as a subset of jobs and/or job titles 224 with similarities 222 that exceed the threshold. Selection apparatus 204 may optionally select and/or adjust the threshold to balance the quantity and/or comprehensiveness of job selections 226 with the relevance of job selections 226 to candidate titles 220.

In some embodiments, selection apparatus 204 filters jobs in job selections 226 by additional attributes. For example, selection apparatus 204 may limit job selections 226 to jobs and/or job titles 224 with seniorities that are the same as or higher than the seniority of the candidate's current job. In another example, selection apparatus 204 may limit job selections 226 to jobs in the same industry, function, and/or location as the candidate's current job. Consequently, job selections 226 may be limited to jobs that are relevant to the candidate's preferences or goals related to job-seeking and/or career path development.

A management apparatus 206 generates job recommendations 244 for the candidate from job selections 226 produced by selection apparatus 204 from candidate titles 220 related to the candidate. As shown in FIG. 2, management apparatus 206 uses machine learning models 238 to generate recommendations 244 from features associated with job selections 226. For example, management apparatus 206 may generate recommendations 244 as search results of the candidates' job searches, search results of recruiters' candidate searches for specific jobs, job recommendations that are displayed and/or transmitted to the candidates, and/or within other contexts related to job seeking, recruiting, careers, and/or hiring.

In one or more embodiments, machine learning models 238 generate output related to the compatibility of candidates with jobs. For example, machine learning models 238 may generate predictions representing the likelihood of a positive outcome between a candidate and a job (e.g., the candidate applying to the job, given the candidate's impression of the job; the candidate receiving a response to the job application; adding of the candidate to a hiring pipeline for the job; interviewing of the candidate for the job; and/or hiring of the candidate for the job).

In one or more embodiments, machine learning models 238 include a global version, a set of personalized versions, and a set of job-specific versions. The global version may include a single machine learning model that tracks the behavior or preferences of all candidates with respect to all jobs in data repository 134. Each personalized version of the model may be customized to the individual behavior or preferences of a corresponding candidate with respect to certain job features (e.g., a candidate's personal preference for jobs that match the candidate's skills). Each job-specific model may identify the relevance or attraction of a corresponding job to certain candidate features (e.g., a job's likelihood of attracting candidates that prefer skill matches).

The output of the global version, a personalized version for a given candidate, and/or a job-specific version for a given job may be combined to generate a score representing the predicted probability of the candidate applying to the job, clicking on the job, and/or otherwise responding positively to an impression or recommendation of the job. For example, scores generated by the global version, personalized version, and job-specific version may be aggregated into a sum and/or weighted sum that is used as the candidate's predicted probability of responding positively to the job after viewing the job.

Features inputted into the global, personalized, and/or job-specific versions of machine learning model may include, but are not limited to, the candidate's title, function, skills, education, seniority, industry, location, and/or other professional and/or demographic attributes. The features may also include job features such as the job's title, industry, function, seniority, desired or required skill and experience, salary range, and/or location.

The features may further include candidate-job features such as cross products, cosine similarities, statistics, and/or other combinations, aggregations, scaling, and/or transformations of the candidate's and/or job's attributes. For example, the candidate-job features may include cosine similarities between standardized versions of all of the candidate's skills and all of the job's skills. The candidate-job features may also, or instead, include similarities 222 between one or more candidate titles 220 associated with the candidate and each job in job selections 226. The candidate-job features may also, or instead, include other measures of similarity and/or compatibility between one attribute of the candidate and another attribute of the job (e.g., a match percentage between a candidate's “Java” skill and a job's “C++” skill).

To generate recommendations 244, management apparatus 206 retrieves, from model repository 236, model-creation apparatus 210, and/or another data source, the latest parameters of one or more machine learning models 238 that generate predictions related to a candidate's compatibility with a job, the likelihood of a positive outcome between the candidate and job, and/or the candidate's strength or quality with respect to requirements or qualifications of the job. Next, management apparatus 206 inputs features for a given candidate and job selections 226 produced by selection apparatus 204 for the candidate into machine learning models 238 to generate a set of scores 240 between the candidate and job selections 226. For example, management apparatus 206 may produce scores 240 in an offline, batch-processing, and/or periodic basis (e.g., from batches of features in data repository 134), or management apparatus 206 may generate scores 240 generated in an online, nearline, and/or on-demand basis (e.g., when a candidate logs in to the online network, views a job, performs a search, applies for a job, and/or performs another action).

In one or more embodiments, scores 240 include representations of predictions from machine learning models 238. For example, management apparatus 206 may apply a logistic regression model, deep learning model, support vector machine, tree-based model, ensemble model, and/or another type of machine learning model to features for a candidate-job pair to produce a score from 0 to 1 representing the likelihood of a positive outcome associated with the candidate and job.

Management apparatus 206 then generates rankings 242 of jobs in job selections 226 by the corresponding scores 240. For example, management apparatus 206 may rank job selections 226 for the candidate by descending predicted likelihood of positively responding to the jobs.

Finally, management apparatus 206 outputs some or all jobs in rankings 242 as recommendations 244 to the corresponding candidates. For example, management apparatus 206 may display some or all job selections 226 that have been ranked by descending scores 240 from machine learning models 238 within a job search tool, email, notification, message, and/or another communication containing job recommendations 244 to the candidate. Subsequent responses to recommendations 244 may, in turn, be used to generate events that are fed back into the system and used to update features, word embedding model 208, machine learning models 238, and/or recommendations 244.

By using embeddings that capture title transition relationships and/or trends to identify job titles 224 that are highly similar to candidate titles 220 held and/or preferred by candidates, the system of FIG. 2 allows job recommendations 244 for the candidates to be selected and/or generated only from the identified job titles 224. For example, the system may identify a strong similarity between a candidate's current title of “Software Engineer” and corresponding job titles 224 of “Senior Software Engineer,” “Software Developer,” “Lead Software Engineer,” Software Engineer Team Lead,” “System Software Engineer,” and “Software Development Engineer” and include only the identified job titles 224 in job selections 226 from which job recommendations 244 are generated. In turn, the system may prevent jobs that lack similarity to the candidates' titles and/or title preferences from appearing in the job recommendations, thereby increasing the relevance and/or quality of the job recommendations for the candidates.

In contrast, conventional techniques may generate recommendations based on exact matches with the candidates' job search queries and/or title preferences, which may limit the recommendations to a small and/or narrow set of jobs. The conventional techniques may also, or instead, score and/or rank lists of jobs that are not filtered to reflect the candidates' explicit or inferred job or title preferences, resulting in recommendation of jobs that lack relevance to the candidates' career or job search preferences. Consequently, the disclosed embodiments may improve computer systems, applications, user experiences, tools, and/or technologies related to user recommendations, employment, recruiting, and/or hiring.

Those skilled in the art will appreciate that the system of FIG. 2 may be implemented in a variety of ways. First, selection apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Selection apparatus 204, model-creation apparatus 210, and management apparatus 206 may additionally be implemented together and/or separately by one or more hardware and/or software components and/or layers.

Second, a number of models and/or techniques may be used to generate embeddings 214, scores 240, and/or rankings 242. For example, the functionality of word embedding model 208 may be provided by a Large-Scale Information Network Embedding (LINE), principal component analysis (PCA), latent semantic analysis (LSA), and/or other technique that generates a low-dimensional embedding space from documents and/or terms. Multiple versions of word embedding model 208 may also be adapted to different subsets of candidates (e.g., different member segments in the community), jobs, and/or attributes, or the same word embedding model 208 may be used to generate embeddings 214 for all candidates and/or jobs. In another example, machine learning models 238 used to generate scores 240 and/or rankings may include regression models, artificial neural networks, support vector machines, decision trees, random forests, gradient boosted trees, naïve Bayes classifiers, Bayesian networks, clustering techniques, collaborative filtering techniques, deep learning models, hierarchical models, and/or ensemble models.

The retraining or execution of word embedding model 208 and/or machine learning models 238 may also be performed on an offline, online, and/or on-demand basis to accommodate requirements or limitations associated with the processing, performance, or scalability of the system and/or the availability of features used to train the machine learning model. Multiple versions of a machine learning model may further be adapted to different subsets of candidates and/or jobs (e.g., different member segments), or the same machine learning model may be used to generate scores 240 for all candidates and/or jobs. Similarly, the functionality of machine learning models 238 may be merged into a single machine learning model that performs a single round of scoring and ranking of job selections 226 for a candidate and/or separated out into more than two machine learning models that perform multiple rounds of scoring, filtering, and/or ranking of job selections 226 according to different sets of features and/or criteria.

Third, the system of FIG. 2 may be adapted to different types of candidates, opportunities, features, recommendations 244, and/or embeddings 214. For example, word embedding model 208 and machine learning models 238 may be used to generate embeddings 214 and scores 240 related to awards, publications, patents, group memberships, profile summaries, academic positions, artistic or musical roles, fields of study, fellowships, scholarships, competitions, hobbies, online dating matches, and/or other attributes that can be grouped under users or other entities.

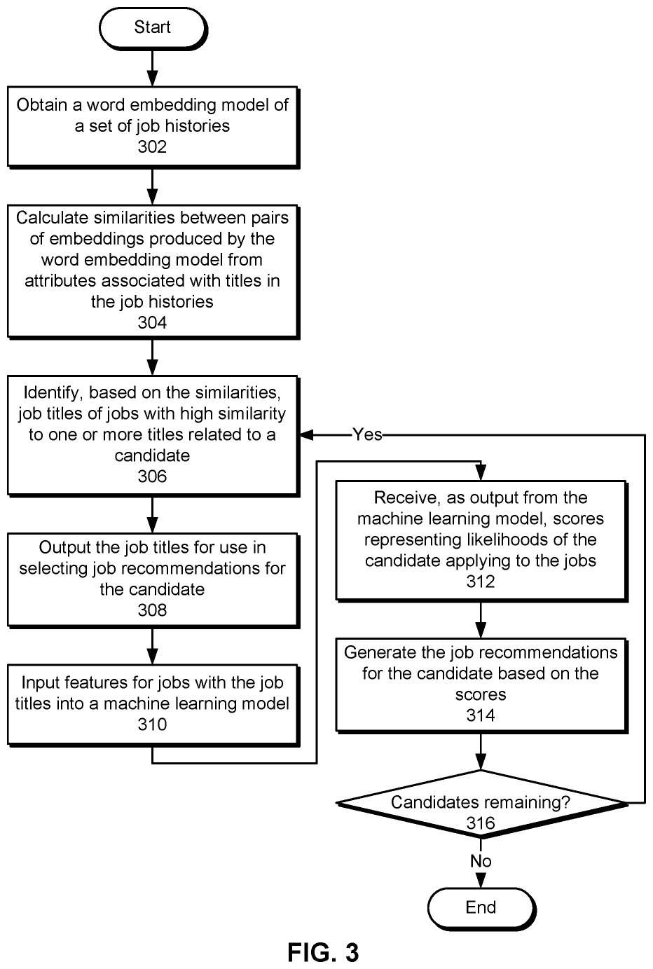

FIG. 3 shows a flowchart illustrating a process of selecting recommendations based on title transition embeddings in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

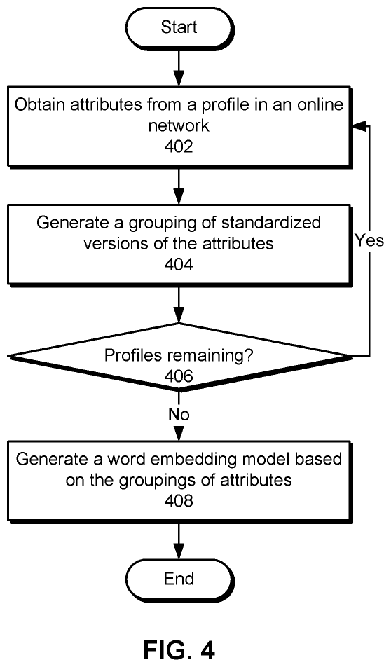

Initially, a word embedding model of a set of job histories is obtained (operation 302). For example, the word embedding model may be created from groupings of attributes in online network profiles, as described in further detail below with respect to FIG. 4. The word embedding model may then be used to generate embeddings from the titles in the job histories, as well as optional attributes associated with the titles (e.g., the industry, company, seniority, and/or location associated with each title).

Next, similarities between pairs of embeddings produced by the word embedding model from attributes associated with titles in the job histories are calculated (operation 304). For example, a cosine similarity and/or other type of vector similarity may be calculated from embeddings of various pairs of jobs in the job histories.

Job titles of jobs with high similarity to one or more titles related to a candidate are identified based on the similarities (operation 306). For example, a threshold may be applied to the similarities to identify job titles of a set of posted jobs as highly similar to the candidate's current, past, and/or preferred titles. The set of posted jobs may also be filtered based on a seniority, industry, function, location, and/or another attribute associated with the candidate's current, past, and/or preferred titles.

The job titles are then outputted for use in selection job recommendations for the candidate (operation 308). For example, a mapping of the candidate's current, past, and/or preferred titles to the job titles may be stored in a data repository for subsequent retrieval and use.

To select job recommendations for the candidate, features for jobs with the job titles are inputted into a machine learning model (operation 310), and scores representing likelihoods of the candidate applying to the jobs are received as output from the machine learning model (operation 312). For example, a global version of the machine learning model may be applied to the features to generate a first set of scores representing the likelihoods of the candidate applying to the jobs. A personalized version of the machine learning model may also be applied to the features to generate a second set of scores representing the likelihoods of the candidate applying to the jobs. A job-specific version of the machine learning model may further be applied to the features to generate a third set of scores representing the likelihoods of the candidate applying to the jobs. The first, second, and/or third sets of scores may then be combined into overall scores ranging from 0 to 1 that represent the candidate's predicted probability of applying to the corresponding jobs.

Finally, job recommendations for the candidate are generated based on the scores (operation 314). For example, the jobs may be ranked by descending score, and a subset of the highest-ranked jobs may be displayed and/or otherwise outputted as recommendations to the candidate. As a result, job recommendations with a higher likelihood of a positive outcome (e.g., applications by the candidate) are outputted before job recommendations with a lower likelihood of a positive outcome.

Operations 302-314 may be repeated for remaining candidates (operation 316). For example, similarities calculated between pairs of titles in operation 304 may be used to identify a set of titles that are similar to a candidate's current, past, and/or preferred title (operation 306). The identified titles may be stored and/or outputted in association with the title and/or candidate (operation 308) and used to generate scores and/or job recommendations for the candidate (operations 310-314). Such generation of job recommendations for candidates may continue until the job recommendations are no longer selected based on similarities between titles related to the candidates and job titles of the jobs.

FIG. 4 shows a flowchart illustrating a process of producing a word embedding model of job histories in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, attributes from a profile in an online network are obtained (operation 402). For example, the attributes may include a member's current and/or past titles, companies, industries, locations, and/or seniorities. The attributes may also, or instead, include the member's schools, fields of study, degrees, and/or other aspects of the member's educational background.

Next, a grouping of standardized versions of the attributes is generated (operation 404). For example, standardized versions of the attributes may be used to form a “sentence” and/or other collection of words that describe the member's job history and/or educational background.

Operations 402-404 may be repeated for remaining members (operation 406). For example, groupings of standardized education and/or job history attributes may be generated for some or all members of an online network (e.g., online network 118 of FIG. 1) and/or from other sources of job histories (e.g., public records, employment websites, etc.).

The word embedding model is then generated based on the groupings of attributes (operation 408) for the members. For example, a word2vec model may be trained using the groupings, so that embeddings produced by the model reflect relationships and/or trends in the members' education and/or job histories. The model and/or embeddings may subsequently be used to calculate similarities between candidate and job titles and/or recommend jobs to candidates based on the similarities, as discussed above.

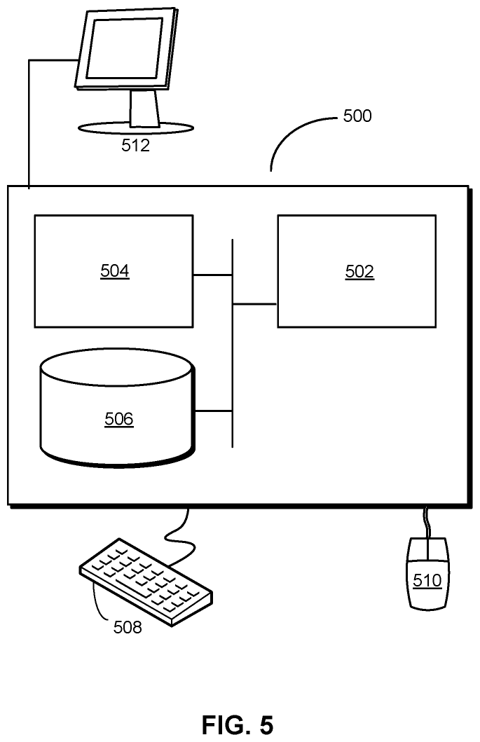

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for selecting job recommendations based on title transition embeddings. The system includes a selection apparatus, a model-creation apparatus, and a management apparatus, one or more of which may alternatively be termed or implemented as a module, mechanism, or other type of system component. The model-creation apparatus obtains and/or creates a word embedding model of a set of job histories. Next, the selection apparatus calculates similarities between pairs of the embeddings produced by the word embedding model from attributes associated with titles in the set of job histories. The selection apparatus then identifies, based on the similarities, job titles with high similarity to a current, past, and/or preferred title of the candidate and outputs the job titles for use in selecting job recommendations for the candidate. Finally, the management apparatus generates the job recommendations for the candidate from jobs with the job titles.

In addition, one or more components of computer system 500 may be remotely located and connected to the other components over a network. Portions of the present embodiments (e.g., selection apparatus, model-creation apparatus, management apparatus, data repository, model repository, online network, etc.) may also be located on different nodes of a distributed system that implements the embodiments. For example, the present embodiments may be implemented using a cloud computing system that generates job recommendations and/or embeddings of job and/or education histories for a set of remote users.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a word embedding model of a set of job histories;
calculating, by one or more computer systems, similarities between pairs of the embeddings produced by the word embedding model from attributes associated with titles in the set of job histories;
identifying, by the one or more computer systems based on the similarities, one or more job titles with high similarity to a current title of a candidate; and
outputting the one or more job titles for use in selecting job recommendations for the candidate.

2. The method of claim 1, further comprising:
identifying, based on the similarities, additional job titles with high similarity to an additional title related to the candidate; and
outputting the additional job titles for use in selecting the job recommendations for the candidate.

3. The method of claim 2, wherein the additional title comprises at least one of:
a title preference for the candidate;
a past title of the candidate; and
a title associated with a job application by the candidate.

4. The method of claim 1, further comprising:
inputting features for jobs with the job titles into a machine learning model;
receiving, as output from the machine learning model, scores representing likelihoods of the candidate applying to the jobs; and
generating the job recommendations for the candidate based on the scores.

5. The method of claim 4, wherein the features comprise at least one of:
a comparison of candidate attributes of the candidate and job attributes of a job; and
a similarity between a first embedding of the current title and a second embedding of the job.

6. The method of claim 1, wherein identifying the job titles with high similarity to the current title of the candidate comprises at least one of:
applying a threshold to a subset of the similarities between the current title of the candidate and additional titles in the set of job histories to identify the job titles with high similarity to the current title; and
filtering the job titles by a set of attributes associated with the current title.

7. The method of claim 6, wherein the set of attributes comprises at least one of:
a minimum seniority;
a location;
an industry; and
a function.

8. The method of claim 1, wherein obtaining the word embedding model of the set of job histories comprises:
determining groupings of attributes from online network profiles that reflect the set of job histories; and
generating the word embedding model based on the groupings of attributes.

9. The method of claim 8, wherein the groupings of attributes comprise at least one of:
a previous title;
a current title;
a company;
a school;
a field of study; and
an industry.

10. The method of claim 1, wherein the similarity comprises a cosine similarity.

11. The method of claim 1, wherein the attributes associated with the titles in the set of job histories comprise at least one of:
a title;
a company; and
an industry.

12. A system, comprising:
one or more processors; and
memory storing instructions that, when executed by the one or more processors, cause the system to:
obtain a word embedding model of a set of job histories;
calculate similarities between pairs of the embeddings produced by the word embedding model from attributes associated with titles in the set of job histories;
identify, based on the similarities, one or more job titles with high similarity to a title associated with the candidate; and
output the one or more job titles for use in selecting job recommendations for the candidate.

13. The system of claim 12, wherein the title associated with the candidate is at least one of:
a current title;
a past title; and
a title preference for the candidate.

14. The system of claim 12, wherein the memory further stores instructions that, when executed by the one or more processors, cause the system to:
input features for jobs with the job titles into a machine learning model;
receive, as output from the machine learning model, scores representing likelihoods of the candidate applying to the jobs; and
generate the job recommendations for the candidate based on the scores.

15. The system of claim 12, wherein identifying the job titles with high similarity to the current title of the candidate comprises at least one of:
applying a threshold to a subset of the similarities between the current title of the candidate and additional titles in the set of job histories to identify the job titles with high similarity to the current title; and
filtering the job titles by a set of attributes associated with the current title.

16. The system of claim 15, wherein the set of attributes comprises at least one of:
a minimum seniority;
a location;
an industry; and
a function.

17. The system of claim 12, wherein the similarity comprises a cosine similarity.

18. The system of claim 12, wherein the attributes associated with the titles in the set of job histories comprise at least one of:
a title;
a company; and
an industry.

19. A non-transitory computer-readable storage medium storing instructions that when executed by a computer cause the computer to perform a method, the method comprising:
obtaining a word embedding model of a set of job histories;
calculating similarities between pairs of the embeddings produced by the word embedding model from attributes associated with titles in the set of job histories;
identifying, based on the similarities, one or more job titles with high similarity to a title related to a candidate; and
outputting the one or more job titles for use in selecting job recommendations for the candidate.

20. The non-transitory computer-readable storage medium of claim 19, wherein the title related to the candidate is at least one of:
a current title;
a past title; and
a title preference for the candidate.
